(19) United States
(12) Patent Application Publication
(10) Pub. No.: US 2011/0235320 A1
(43) Pub. Date: Sep. 29, 2011

(54) DETACHABLE LAMP HOLDER OF LED LAMP

(75) Inventors: Xiangfa Cai, Zhongshan City (CN); Baocheng Fu, Zhongshan City (CN)

(73) Assignee: Honeywell Lonon Electrical Systems Technology (Guangdong)Co., Ltd., Guangdong (CN)

(21) Appl. No.: 13/131,778

(22) PCT Filed: Nov. 11, 2009
(86) PCT No.: PCT/CN2009/074898

§ 371 Date: Jun. 3, 2011

(30) Foreign Application Priority Data
Nov. 28, 2008 (CN) 200820204327.0

(51) Int. Cl. F21V 21/002

(52) U.S. Cl. 362/217.17

(57) ABSTRACT

A detachable lamp holder (1) of a LED lamp has a cover-shaped shell (11) matched with a LED tube (2). The bottom of the cover-shaped shell (11) is provided with pins (12) connecting to the power supply and LED light sources. The cover-shaped shell (11) comprises a hollow sleeve (116) and a hollow sleeve cover (111) being detachably connected, and a base (113) coaxially disposed between the sleeve (116) and the sleeve cover (111). The base (113) forms the bottom part of the cover-shaped shell (11), and the pins (12) are fixed to the base (113). When the LED lamp is partially damaged and needs to be maintained or replaced, the sleeve cover (111) as a part of the lamp holder is screwed off, and the lamp holder and the PCB in the lamp tube can be taken off, thus realizing easy maintenance and replacement.

### TECHNICAL FIELD

The invention relates to a fitting of a LED lamp, in particular to a lamp holder structure of a LED.

### BACKGROUND TECHNOLOGY

With increasingly serious energy crisis, the application of the LED in ambient illumination is more and more important. Under the unremitting efforts of all the countries in the world for many years, the white-light LED has significant development and makes a wave of applying the LED in the illuminating field, and especially the aspect of local illumination of decorative lamps and some high-grade places, the application is wider. Under the promotion of the global energy-saving emission-reducing policy, a new round of energy-saving modification engineering in ambient illumination has started. However, the existing lamp holder structure of the LED lamp which can be interchanged with the fluorescent lamp is generally a connection structure that allows only one-connection, and after the finished product is assembled, the lamp holder and the lamp tube can not be detached. If the PCB (light source part) of the LED lamp is partially damaged and needs to be maintained, the connection between the lamp holder and the lamp tube needs to be damaged, so as to bring inconvenience for detection, maintenance and replacement. Simultaneously, in the production process, the connection between the lamp holder and the lamp tube is more troublesome.

### DISCLOSURE OF THE INVENTION

### Technical Problem

The invention aims at overcoming the defects of the prior art and providing a detachable lamp holder of a LED lamp.

### Technical Solution

The invention is implemented by the following technical solution: a detachable lamp holder of a LED lamp has a cover-shaped shell matched with a LED tube. The bottom of the cover-shaped shell is provided with pins connecting to the power supply and LED light sources. The detachable lamp holder of the LED lamp is characterized in that the cover-shaped shell comprises a hollow sleeve and a hollow sleeve cover being detachably connected, and a base coaxially disposed between the hollow sleeve and the hollow sleeve cover. The base forms the bottom part of the cover-shaped shell, and the pins are fixed to the base.

The sleeve comprises a first end combined with the LED tube and a second end matched with the base, and the second end is externally provided with external threads which are in threaded connection with internal threads arranged in the sleeve cover; the bottom of the sleeve cover is provided with a step, and when the sleeve and the sleeve cover are connected together, the end surface of the step of the sleeve cover presses the base tightly.

The front end surface of the base is provided with a positioning ring matched with the inner diameter of the second end of the sleeve, a gap is arranged along the circumferential direction of the positioning ring, the inner surface of the second end of the sleeve is provided with a positioning block corresponding to the gap, and when the positioning ring of the base is inserted into the second end of the sleeve, the positioning ring and the gap on the positioning ring are mutually clamped.

A sealing ring is arranged between the sleeve and the base and is sheathed at the outer part of the positioning ring of the base.

The inner wall of the first end of the sleeve is provided with a plurality of convex edges axially distributed.

As further improvement of the invention, the inner bottom part of the cover-shaped shell is provided with a conductive clip which is connected with the end parts of the pins. The conductive clip comprises a substrate connected with the pins mutually and two groups of clip feet arranged on the substrate, and a clamping groove is formed between the two groups of clip feet.

Each group of clip feet comprises one or more clip feet, and the two groups of clip feet are mutually and oppositely arranged.

As more further improvement of the invention, the inner bottom part of the cover-shaped shell is provided with a supporting baffle for supporting the clip feet of the conductive clip. The positions on the side wall of the supporting baffle, which correspond to the clip feet, are provided with grooves, and the width of each groove is consistent to that of the clip foot.

### Beneficial Effects

Compared with the prior art, the invention has the beneficial effects that since the lamp holder consists of a plurality of detachable parts, and when the LED lamp is partially damaged and needs to be maintained or replaced, the sleeve cover as a part of the lamp holder is screwed off, and the base and the PCB in the lamp tube can be taken off, thus realizing the purposes of easy maintenance and replacement. In addition, the inner side of the base of the invention is provided with the conductive clip which can be directly clamped with the PCB of the LED light source forming electric connection, therefore, the installation, replacement and maintenance of the LED lamp and the replacement of the common fluorescent lamp with the LED light source become very convenient and fast.

### DESCRIPTION OF THE DRAWINGS

FIG. 1 is an exploded view of the lamp holder in the embodiment of the invention;

FIG. 2 is an exploded view of the LED lamp applying the lamp holder in FIG. 1;

FIG. 3 is a three-dimensional view of the LED lamp in FIG. 2 (partial);

FIG. 4 is an exploded view of the conductive clip and the base;

FIG. 5 is an application of the detachable lamp holder in the embodiment on the LED lamp.

### IMPLEMENTATION MODE OF THE INVENTION

Further description is made for the detachable lamp holder of the LED lamp of the invention by reference of the drawings and the detailed implementation mode:

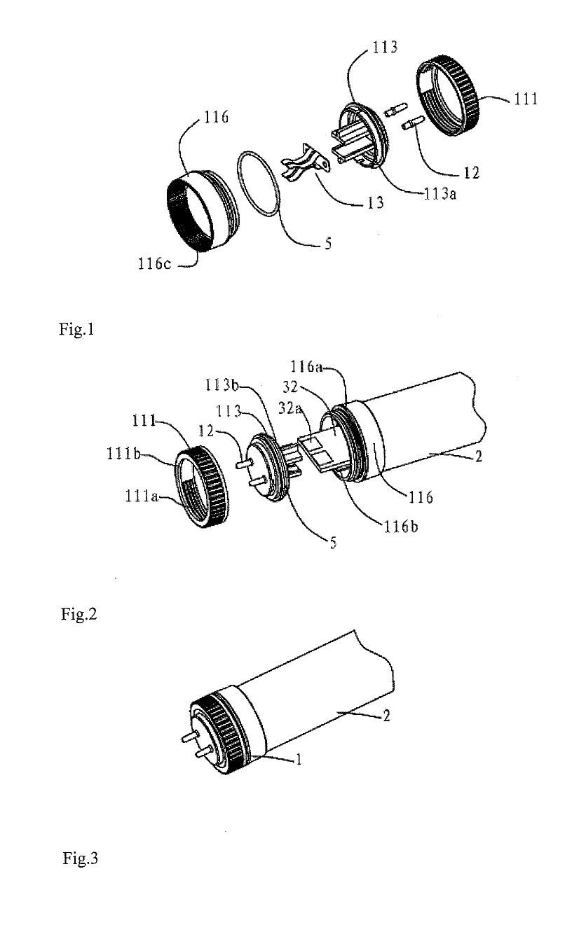

Shown as the FIG. 1, the lamp holder I mainly comprises a cover-shaped shell 11 which consists of a sleeve 116, a sleeve cover 111 and a base 113 which are coaxially disposed, and further comprises two pins 12 used for connecting the power supply and LED light sources and a conductive clip 13 as well as a waterproof and anti-mist sealing ring 5. The base 113 forms the bottom part of the cover-shaped shell 11, and the pins 12 and the conductive clip 13 are fixed on the base 113. Shown as the FIGS. 1-4, both the sleeve 116 and the sleeve cover 111 are hollow shells. The sleeve 116 comprises a first end combined with the outer diameter of the lamp tube 1 and a second matched with the base 113, and the second end is externally provided with external threads 116a which are in threaded connection with internal threads 111a arranged in the sleeve cover 111; the bottom of the sleeve cover 111 is provided with a step 111b, and when the sleeve 116 and the sleeve cover 111 are connected together by the threads, the end surface of the step 111b of the sleeve cover 111 presses the base 113 tightly so as to connect the sleeve 116, the sleeve cover 111 and the base 113 together. In addition, the front end surface of the base 113 is provided with a positioning ring 113a matched with the inner diameter of the second end of the sleeve 116, a gap 113b is arranged along the circumferential direction of the positioning ring 113a, the inner surface of the second end of the sleeve 116 is provided with a positioning block 116b corresponding to the gap 113b, and when the positioning ring 113a of the base 113 is inserted into the second end of the sleeve 116, the positioning ring 116b and the gap 113b on the positioning ring 113a are mutually clamped, thus guaranteeing that the base 113 can not rotate randomly, and simultaneously also guaranteeing the reliability of electric connection among the pins 12 connected with the base 113, the conductive clip 13 and the PCB 32.

In addition, the sealing ring 5 is arranged between the sleeve 116 and the base 113 and is sheathed at the outer part of the positioning ring 113a at the front end of the base 113, thus preventing vapor and mist from entering the inner part of the lamp tube 2 and playing waterproof and anti-mist roles.

The FIGS. 3-5 are examples of the lamp holder 1 applied on the tube-shaped LED lamp. The LED lamp comprises two lamp holders 1 (in the FIG. 5, the cover-shaped shell of the lamp holder 1 at the left end is detachable, the cover-shaped shell of the lamp holder 11 at the right end is integrated, certainly it is better that both the two ends adopt the detachable lamp holder shown as the left end), a lamp tube 2, a group of LED light sources 3 and a light source bracket 4 and other components. The LED light sources 3 are arranged on the PCB 32, the two ends of the PCB 32 are power input ends 32a electrically connected with the LED light sources 3 and the lamp holders 1 and the power input ends 32a of the PCB 32 are mutually clamped to form electric connection.

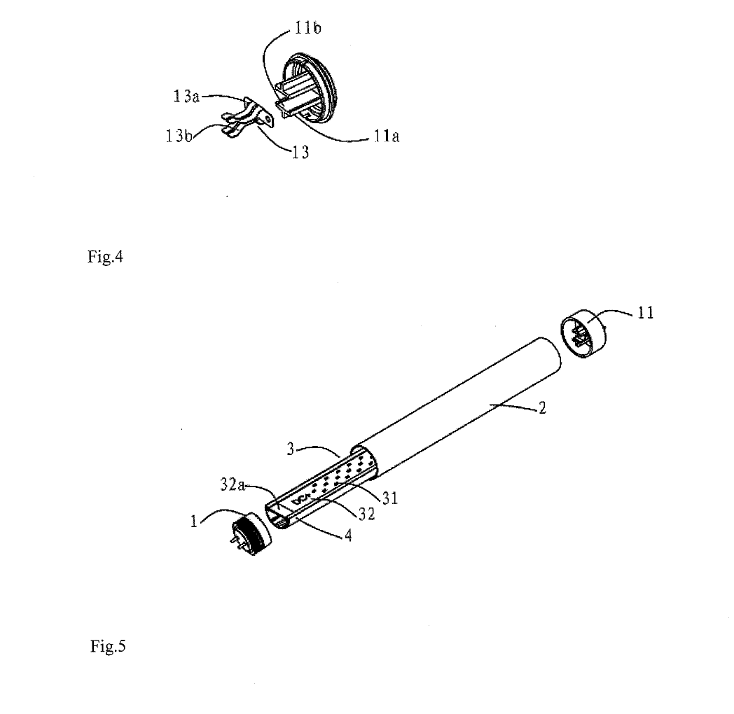

The sleeve 116, the sleeve cover 111 and the base 113 of the lamp holder 1 can be made of PC plastic materials. The pins 12 and the conductive clip 13 are mutually connected and are made of copper. The conductive clip comprises a substrate 13a which is mutually riveted with the pins 12 and two groups of clip feet 13b arranged on the substrate 13a, a clamping groove for clamping the power input ends 32a of the PCB 32 is formed between the two groups of the clip feet 13b, and when the LED lamp is assembled, the PCB 32 is clamped in the clamping groove. Shown as the FIG. 4, the two groups of clip feet comprise two clip feet which are oppositely arranged respectively, certainly, in the two groups of clip feet, one group of clip feet can comprise two clip feet, the other group of clip foot only comprises one clip foot, the three clip feet are arranged in a staggering manner, and are distributed in a shape like a Chinese character ‘pin’. Wherein, the substrate 13a and all the groups of clip feet 13b are integrally punched, bent and formed. The conductive clip 13 clips the power input ends 32a of the PCB 32.

Shown as the FIG. 5, the lamp tube 2 is a transparent or semitransparent straight tube, and is internally provided with the stripy bracket 4, and the two sides of the PCB 32 are clamped on the bracket 4. The bracket 4 is a plastic profile formed by extrusion. The lamp tube 2 can be a circular tube, a square tube and an oval tube and the like.

In addition, in order to guarantee that the conductive clip 13 can not deform due to being collided and prevent electric shock and the like, shown as in the FIG. 4, the inner bottom part of the base 113 of the lamp holder 1 is provided with a supporting baffle 11a for supporting the clip feet 13b of the conductive clip 13. The positions on the side wall of the supporting baffle 11a, which correspond to the clip feet 13b, are provided with grooves 11b, and the width of each groove 11b is consistent to that of the clip foot 13b. When the lamp holder 1 and the PCB 32 are mutually clamped, the clip feet 13b can generate elastic deformation along the grooves 11b, so that the PCB can be clamped into the conductive clip 13 smoothly.

Shown as in the FIG. 5, the LED light sources 3 consist of a plurality of low-power high-brightness surface-mounted LEDs 31 which are distributed in a dot matrix manner. A surface-mounted technology is adopted to weld a stripy LED belt formed on the PCB 32, and the PCB is inserted in the clamping groove of a flame-retardant ABS bracket 4 which plays a role in rigid support and guarantees that the LED light sources 3 are not bent. The LED light sources 3 are placed on the lamp tube 2 (the material is transparent glass or transparent plastics, and the length of the lamp tube is designed by reference of the overall dimension and the length dimension of a double-end fluorescent lamp), the first ends of the sleeves 116 of the two lamp holders 1 are packaged at the two ends of the lamp tube 2 in a manner of gluing or tight matching, and the conductive clips 13 of the lamp holders 1 clip the power input ends at the two ends of the PCB respectively so as to form a lamp similar to the double-end fluorescent lamp. Wherein, the inner walls of the first ends of the sleeves 116 are provided with a plurality of convex edges 116c which are axially distributed and can guarantee tight connection between the sleeves 116 and the lamp tube 2.

### INDUSTRIAL APPLICABILITY

Therefore, the process of adopting the LED lamp of the lamp holder in the embodiment to replace the common fluorescent lamp can be very simple, convenient and fast.

1. A detachable lamp holder of a LED lamp has a cover-shaped shell matched with a LED tube. The bottom of the cover-shaped shell is provided with pins connecting to the power supply and LED light sources. The cover-shaped shell comprises a hollow sleeve and a hollow sleeve cover being detachably connected, and a base coaxially disposed between the hollow sleeve and the hollow sleeve cover. The base forms the bottom part of the cover-shaped shell, and the pins are fixed to the base.

2. The detachable lamp holder of the LED lamp according to claim 1, wherein the sleeve comprises a first end combined with the LED tube and a second end matched with the base, and the second end is externally provided with external threads which are in threaded connection with internal threads arranged in the sleeve cover; the bottom of the sleeve cover is provided with a step, and when the sleeve and the sleeve cover are connected together, the end surface of the step of the sleeve cover presses the base tightly.

3. The detachable lamp holder of the LED lamp according to claim 2, wherein the front end surface of the base is provided with a positioning ring matched with the inner diameter of the second end of the sleeve, a gap is arranged along the circumferential direction of the positioning ring, the inner surface of the second end of the sleeve is provided with a positioning block corresponding to the gap, and when the positioning ring of the base is inserted into the second end of the sleeve, the positioning ring and the gap on the positioning ring are mutually clamped.

4. The detachable lamp holder of the LED lamp according to claim 3, wherein a sealing ring is arranged between the sleeve and the base and is sheathed at the outer part of the positioning ring of the base.

5. The detachable lamp holder of the LED lamp according to claim 2, wherein the inner wall of the first end of the sleeve is provided with a plurality of convex edges axially distributed.

6. The detachable lamp holder of the LED lamp according to claim 1, wherein the inner bottom part of the cover-shaped shell is provided with a conductive clip which is connected with the end parts of the pins.

7. The detachable lamp holder of the LED lamp according to claim 6, wherein the conductive clip comprises a substrate connected with the pins mutually and two groups of clip feet arranged on the substrate, and a clamping groove is formed between the two groups of clip feet.

8. The detachable lamp holder of the LED lamp according to claim 7, wherein the each group of clip feet comprises one or more clip feet, and the two groups of clip feet are mutually and oppositely arranged.

9. The detachable lamp holder of the LED lamp according to claim 6, wherein the inner bottom part of the cover-shaped shell is provided with a supporting baffle for supporting the clip feet of the conductive clip.

10. The detachable lamp holder of the LED lamp according to claim 9, wherein the positions on the side wall of the supporting baffle, which correspond to the clip feet, are provided with grooves, and the width of each groove is consistent to that of the clip foot.
